(19) United States
(12) Patent Application Publication
(10) Pub. No.: US 2004/0159395 A1
(43) Pub. Date: Aug. 19, 2004

(54) Process and apparatus for producing folding coupons

(76) Inventors: Heinz Focke, Verden (DE); Thomas Hafker, Langwedel (DE); Jens Schmidt, Grasberg (DE); Jurgen Focke, Verden (DE); Doris Focke, Verden (DE)

Correspondence Address: SUGHRUE MION, PLLC, 2100 PENNSYLVANIA AVENUE, N.W., SUITE 800, WASHINGTON, DC, 20037, US

(21) Appl. No.: 10/702,083

(22) Filed: Nov. 6, 2003

(30) Foreign Application Priority Data
Nov. 8, 2002 (DE) 102 52 550.1

(51) Int. Cl. B65C 1/00

(52) U.S. Cl. 156/204; 156/443

(57) ABSTRACT

For producing folded printing carriers—folding coupons (10)—use is made of an apparatus which is designed as a unit and in the case of which a continuous material web (11) is provided with regions of hot-melt glue. Blanks (25) are cut off from the material web (11) prepared in this way and are fed to a folding subassembly (26) in order to be folded transversely a number of times. Following the folding subassembly (26), the folding coupons (10) are subjected to the action of heat and pressure by a handling arrangement (34).

The invention relates to a process for producing blanks made of thin material which are folded, in particular, a number of times, in particular printing carriers or coupons made of paper—folding coupons—the folding coupon being folded to produce at least two folding legs which are connected to one another (in a releasable manner) by adhesive bonding. The invention also relates to an apparatus for carrying out the process.

The folding coupon is added to packs, to be precise cigarette packs in particular. The aim is to supply to the consumer, along with the cigarette pack, a printing carrier which has the largest possible surface area and contains information, advertisements or vouchers. In the first instance, the folding coupons, which are usually folded a number of times, are separated off as a blank from a material web (paper) and conveyed through a folding subassembly (buckle folder), which folds the blank (a number of times). Following the folding subassembly, at least two folding legs of the folding coupon are connected to one another by punctiform or surface-area adhesive bonding. The resulting folding coupon is introduced into the production and/or folding process of the (cigarette) pack and positioned within the pack. In the case of cigarette packs, it is customary for the folding coupon to be placed between the actual cigarette pack and an outer wrapper made of film. As an alternative, it is also possible for the folding coupon to be fastened on the outside of the outer wrapper.

It is important for such folding coupons to be produced and made available cost-effectively.

The object of the invention is to carry out the production of folding coupons which are folded, in particular, a number of times such that the folding coupons can be fed to the pack itself without performance being compromised during production of said pack.

In order to achieve this object, the process according to the invention is characterized by the following features:

a) areas of glue or regions of glue for adhesively bonding folding legs are applied in a precise position to a continuous material web for producing the folding coupons,

b) the regions of glue consist of hot glue (hot melt),

c) blanks are cut off from the material web provided with set regions of glue and are fed to a folding subassembly for carrying out folding operations and/or for producing the folding coupons,

d) once the blank has been folded, the regions of glue, consisting of hot glue, are activated by the supply of heat and the folding legs are connected to one another by pressure.

Using regions of glue or areas of glue, namely spots of glue or small expanses of glue, consisting of hot-melt adhesive, makes it possible for the regions of glue to be applied to the material web, in accordance with the position on the finished folding coupon.

During production of folding coupons from a material web which is of double width and/or folded in a double layer, two or more areas of glue or regions of glue are to be applied to the material web—before the material web is folded transversely in order to create the double-layered formation—the areas of glue or regions of glue being positioned such that in each case outer folding legs, if appropriate three outer folding legs, are connected to one another.

The special feature of the apparatus according to the invention is that it is an independent unit which can be fitted on a packaging machine such that the finished folding coupons are transferred directly to the packaging machine, to be precise to a film-wrapping machine in particular.

The apparatus is provided with at least one glue subassembly for the purpose of applying the regions of glue in accordance with printed marks provided on the material web. Furthermore, an activating subassembly for hot melts, which follows the folding subassembly for the folding coupons, is designed in a particular manner.

Details of the apparatus and of the blanks or folding coupons which are to be produced are explained more specifically hereinbelow with reference to the drawings, in which:

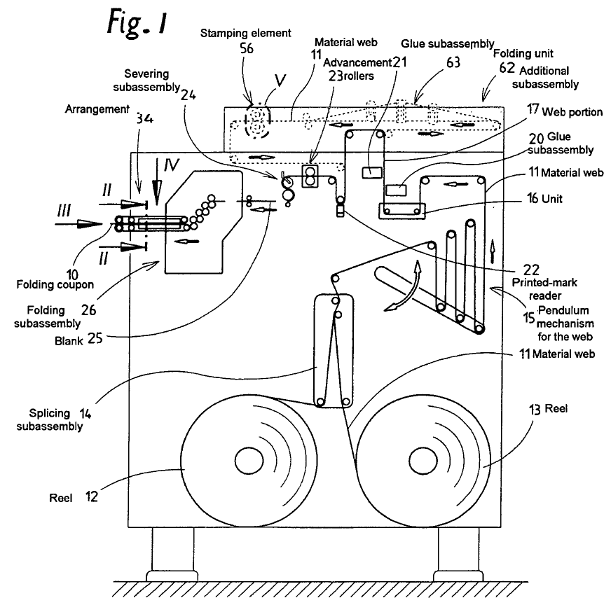

FIG. 1 shows a schematic side view of an apparatus for producing folding coupons from material webs,

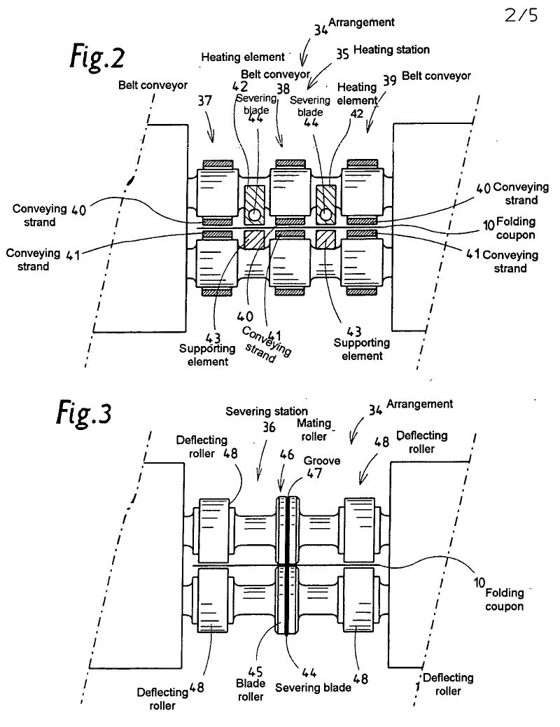

FIG. 2 shows, on an enlarged scale, a detail of the apparatus according to FIG. 1, namely a glue-activating subassembly, in a cross section along section plane II-II in FIG. 1,

FIG. 3 shows the activating subassembly according to FIG. 2 in an end view according to arrow III in FIG. 1,

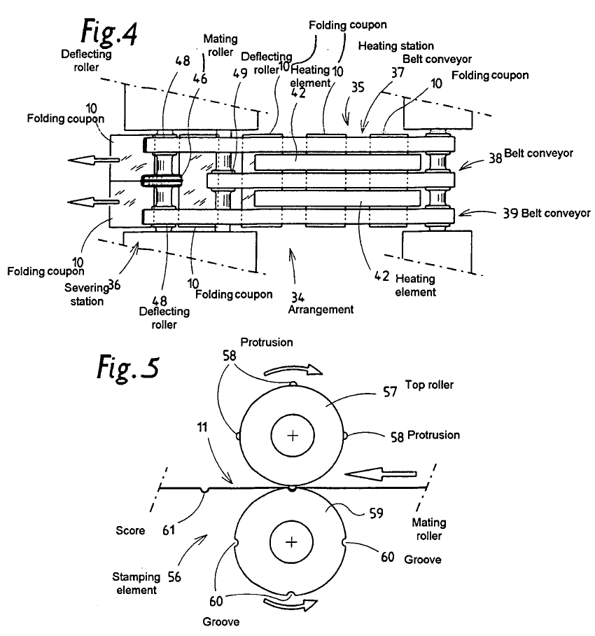

FIG. 4 shows, likewise on an enlarged scale, the activating subassembly according to FIGS. 2 and 3 in a plan view corresponding to the arrow IV in FIG. 1,

FIG. 5 shows a further detail of the apparatus, namely a scoring subassembly, in a side view and on an enlarged scale (detail V in FIG. 1),

FIG. 6 shows a (doubled) folding coupon in plan view,

FIG. 7 shows a cross section through the folding coupon according to FIG. 6 along section plane VII-VII,

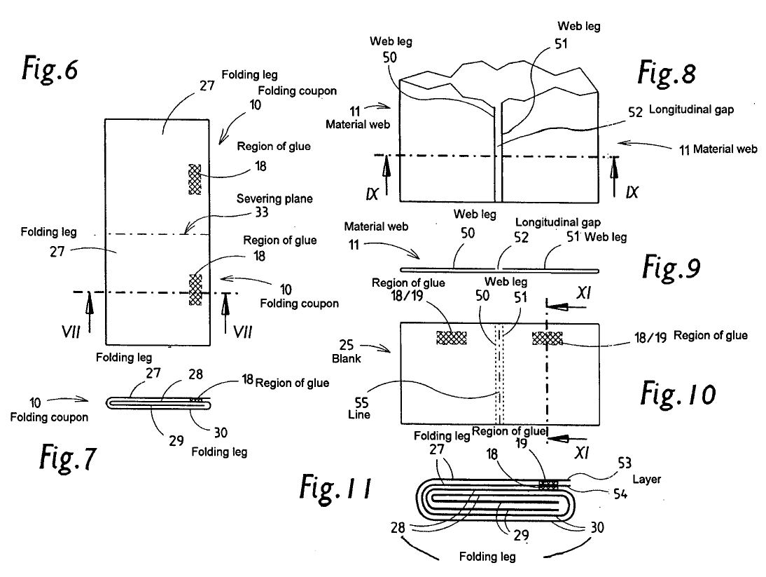

FIG. 8 shows a plan view of a portion of a material web for producing blanks for folding coupons,

FIG. 9 shows a cross section through the material web according to FIG. 8 along section plane IX-IX,

FIG. 10 shows a plan view of a (doubled) folding coupon comprising a material web according to FIGS. 8 and 9,

FIG. 11 shows the folding coupon according to FIG. 10 in a cross section along section plane XI-XI,

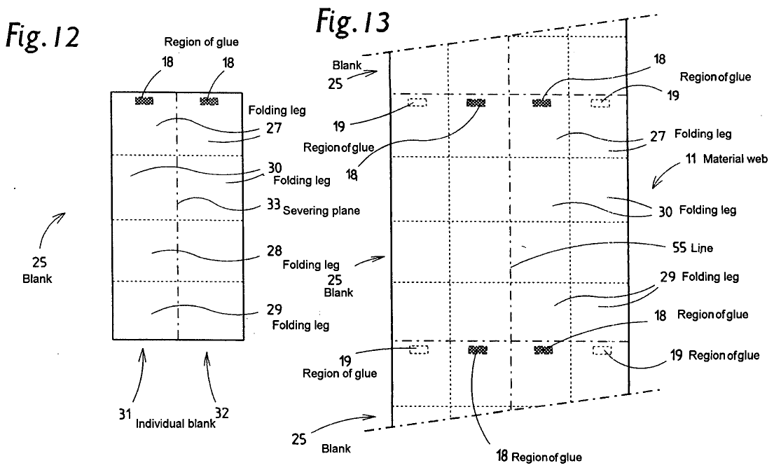

FIG. 12 shows a (doubled) blank for producing folding coupons according to FIGS. 6 and 7, and

FIG. 13 shows a portion of a material web for producing folding coupons according to FIGS. 10 and 11.

The apparatus for producing folded printing carriers, namely folding coupons 10, which is shown schematically in FIG. 1, is designed as an independent unit with a machine framework and/or machine housing. The apparatus may be connected to a packaging machine in order to introduce the finished folding coupons 10 into the packaging process. An advantageous solution which is suitable for this purpose can be gathered from EP 1 125 843.

The folding coupons 10 are produced from a continuous material web 11 made of paper or similar material. The material web 11 is drawn off in each case from a reel 12, 13, which is a constituent part of the apparatus. The material web 11 runs through a splicing subassembly 14 for the purpose of connecting an outgoing material web to a new one. This is followed by a pendulum mechanism 15 for the web, which, as a compensating store, produces a plurality of web loops. The material web 11 then passes into the top part of the apparatus, in which preparation for the production of folding coupons 10 takes place.

For producing the folding coupons 10, in the first instance the material web 11 has to be oriented precisely in the movement direction and, for this purpose, runs through an edge-control unit 16. Thereafter, the material web 11 is deflected to form an upright or vertical web portion 17. In this region, the material web 11 is provided with glue, namely with spots of glue or regions of glue 18, 19. The glue is transferred by glue subassemblies 20, 21 which preferably operate by the contact-gluing principle, that is to say using contact nozzles which briefly butt against the material web in order to transfer one or more regions of glue 18, 19. The glue subassemblies 20, 21 are arranged on both sides of the material web 11, to be precise in a state in which they are offset in height in relation to one another.

Following a double deflection at the top and a subsequent vertical portion of the material web 11, the latter passes into the region of a printed-mark reader 22. The material web 11 is provided with precisely positioned printed marks, by means of which certain elements can be controlled. The printed-mark reader 22 is an, in particular, optoelectronic sensor which senses the printed marks and then generates control signals.

By virtue of renewed deflection of the material web 11, the latter passes into the region of advancement rollers 23. By virtue of a corresponding drive, these give rise to a precise, preferably continuous conveying movement of the material web 11, to be precise to a severing subassembly 24 for the purpose of cutting off planar, non-folded blanks 25 from the material web 11. The severing subassembly 24 comprises a circulating blade roller with a fixed mating blade. The severing subassembly 24 is controlled via the printed-mark reader 22.

The blanks 25 are conveyed one after the other, by conveying elements, into a folding subassembly 26 (buckle folder). Folding coupons 10 which have been folded to the full extent leave the folding subassembly 26 on an outlet side.

The folding coupons 10 may be designed in different ways. A first configuration is shown in cross section in FIG. 7. In this case, the blank 25 is folded such that a total of four folding legs 27, 28, 29, 30 are produced. The folding is carried out such that an inner folding leg 29 is covered by folding legs 28 and 30. An outer folding leg 27 is connected to the adjacent inner leg 28, to be precise by a region of glue 18 of the abovedescribed configuration which is directed towards a free border of the folding leg 27.

A folding coupon 10 designed in this way is produced by folding an elongate, rectangular blank (FIG. 12). In the present case, use is made of a double web, that is to say a material web 11 of double width. According to FIG. 12, the blank 25 which is cut off from the material web 11 and fed to the folding subassembly 26 is thus of double width and comprises two adjacent individual blanks 31, 32. The individual folding legs 27 . . . 30 are indicated by transversely directed, dashed lines, these lines, at the same time, being transversely directed folding lines. Each of the individual blanks 31, 32 is assigned a region of glue 18. The blank 25 comprising the two individual blanks 31, 32 is introduced into the folding subassembly 26. A folding coupon of double width thus passes out of the latter (FIG. 6). This coupon is severed in the region of a central severing plane 33, with the result that two individual folding coupons 10 of the configuration according to FIG. 7 are then produced. Prior to the severing cut (or, alternatively, thereafter), the regions of glue 18, consisting of hot melt, are (re)activated by the supply of heat. Furthermore, the folding legs 27 . . . 30 are pressed against one another to produce a connection between the folding legs 27 and 28 in the area of the region of glue 18.

In the case of the apparatus according to FIG. 1, the folding subassembly 26 is followed by a specifically designed arrangement 34, which completes the folding coupons 10. The arrangement 34 comprises a heating station 35 and a severing station 36. The (double-width) folding coupons 10 passing out of the folding subassembly 26 pass directly into the arrangement 34 for post-treatment and are transported by a coupon conveyor through the heating station 35 and then through the severing station 36.

For this purpose, the arrangement 34 comprises a plurality of belt conveyors 37, 38, 39. Each of these belt conveyors 37 . . . 39 comprises two top and bottom endless belts located opposite one another. The folding coupons 10 are transported between facing conveyor strands 40 and 41. The belt conveyors 37, 38, 39, which are arranged on common shafts or spindles, are spaced apart from one another. In each case one heating element 42 is arranged between adjacent belt conveyors 37, 38, on the one hand, and 38, 39, on the other hand. The heating elements are formed by elongate heaters which run in the transporting direction and have a heating member, e.g. a heating cartridge. This produces the necessary temperature for reactivating the glue of the regions of glue 18, 19. In the case of the present example (FIG. 2), for each folding coupon 10, a heating element 42 is positioned above the movement path of the respective folding coupon 10, to be precise in the area of the region of glue 18, 19. For optimum heat transmission, it is directed upwards. Arranged beneath the heating elements 42 in each case are elongate supporting elements 43, which fill the interspace formed between the belt conveyors.

Accordingly, in the heating station 35 which is designed in this way, the heating elements 42, 43 apply the necessary heat and the conveying strands 40, 41 apply the necessary pressure to the folding legs 27, 28 which are to be connected to one another.

Following the heating station 35, the (double-width) folding coupons are severed centrally by a severing blade 44. The severing blade 44 is fitted on the circumference of a blade roller 45. A mating roller 46 is provided with an encircling groove 47 in the region of action of the severing blade 44. The blade roller 45 is arranged beneath, and the mating roller 46 is arranged above, the movement path of the folding coupons 10.

The coupon conveyor extends over the two stations. For this purpose, the border-side belt conveyors 37, 39 run into the region of the severing station 36. Deflecting rollers 48 for the belt conveyors 37, 39 are mounted on a common spindle with the blade roller 45 and mating roller 46. The central belt conveyor 38 terminates at a distance from the blade roller 45, on a deflecting roller 49 of a transverse spindle fitted in this region.

The folding coupon 10 according to FIG. 11 constitutes a special feature. This coupon is folded in basically the same way as the folding coupon 10 according to FIG. 7, but using double-layered material or a double-layered blank 25.

For producing such a folding coupon 10, use is made of a double-layered material web 11 according to FIGS. 8 and 9. The originally double-width material web 11 is double-layered as a result of web legs 50, 51 being folded over along the borders, this producing folding edges along the borders of the material web 11. The web legs 50, 51 are dimensioned such that, in the longitudinal centre of the material web 11, a small distance, namely a longitudinal gap 52, is produced between the facing borders of the web legs 50, 51.

Blanks 10 are cut off from the resulting material web 11 (FIG. 8) and transferred to the folding subassembly 26. The blank 25 which is prepared for this type of folding coupon 10 has the cross-sectional shape which is shown in FIG. 9 and, in plan view, the structure which can be seen from FIG. 8.

Basically the same folding steps are carried out to form in each case double-layered folding legs 27, 28, 29, 30, the outer, free folding leg 27 comprising two layers 53, 54. The two layers 53, 54 are connected to one another by an (additional) region of glue 19. The entire folding leg 27, or the inner layer 54 thereof, is connected by the region of glue 18 to a facing layer of the next-following folding leg 28. It is also necessary to prepare the material web 11 for the specific configuration of the folding coupon 10 according to FIG. 11 in respect of the application of the regions of glue 18, 19.

FIG. 13 shows part of the material web 11 for a folding coupon 10 according to FIG. 11, to be precise before the web legs 50, 51 are folded. A central chain-dotted line 55 indicates the severing plane, in the region of which the double-width, double-layered folding coupon according to FIG. 10 is severed. The dashed lines show the folding lines, the longitudinally running lines corresponding to the folding edges along the borders of the double-layered material web 11 according to FIG. 9. On account of the specific adhesive bonding of free folding legs according to FIG. 11, each sub-web of the material web 11 is assigned two regions of glue 18, 19. These are positioned on different sides, that is to say on the top side and underside, of the material web 11. By virtue of the material web 11 being folded in the longitudinal direction and then folded transversely in the region of the folding subassembly 26, the regions of glue 18, 19 move into a congruent position corresponding to FIG. 11. Alternatively, the regions of glue 18, 19 may be offset in relation to one another at least in the transverse direction of the material web 11, with the result that, when the folding coupon 10 is in the finished state, the relevant regions of glue 18, 19 are likewise offset in the transverse direction.

It is also the case with the exemplary embodiment that, in the region of the arrangement 34 for post-treatment, the double-width folding coupon 10 (configuration according to FIG. 10) is severed in the longitudinal centre, namely along the line 55. The severing cut is carried out in the region of the longitudinal gap 52, with the result that the (folded) web legs 50, 51 are not effected by the severing cut.

A further special feature is shown in FIG. 5. If use is made of materials of relatively high strength for the folding coupon 10, but in particular in the case of multi-layered folding coupons 10 (configuration according to FIG. 11), deformation of the material and/or of the material web 11 may be expedient. A stamping element 56 according to FIG. 5 is provided for this purpose. The stamping element 56 comprises two stamping rollers, namely a top roller 57 with rib-like protrusions 58 and a bottom, mating roller 59 with grooves 60 running in the axis-parallel direction. The material web 10 in the non-folded state, or folded in accordance with FIGS. 8 and 9, is conveyed through between the two rollers. Transversely directed scores 61 are formed in the material and/or in the material web 11 in the process. These scores 61 correspond to the folding lines during the production of the folding coupon 10 in the folding subassembly 26. The distances between the protrusions 58 and between the grooves 60 correspond to the positions of transverse folding lines which are produced in the region of the folding subassembly 26. Protrusions 58 and grooves 60 interact during the stamping operation.

The apparatus for producing folding coupons 10 (FIG. 1) is expediently set up such that it is alternatively possible to produce either of the configurations of folding coupons 10 according to FIGS. 7 and 11. For the production of folding coupons 10 of the last-mentioned configuration, use is made of an additional subassembly 62 of the apparatus. This is fitted on the top side of the apparatus and can be either a fixed constituent part of the apparatus or fitted in a removable manner thereon.

If the intention is to produce folding coupons 10 of the configuration of FIG. 11, the material web 11, following gluing and/or following the glue subassemblies 20, 21, is deflected horizontally and conveyed through the additional subassembly 62 (dashed illustration) in the opposite direction to the abovedescribed exemplary embodiment (arrows in FIG. 1). Following deflection, the material web 11 runs through a schematically shown folding unit 63. This is designed in a known manner such that, during transportation, the two web legs 50, 51 are folded continuously into the position according to FIGS. 8 and 9. Following the folding unit 63, the now double-layered material web 11 is conveyed through the already described stamping element 56. After having been deflected twice, the material web 11 prepared in this way then passes back into the region of the already described apparatus, that is to say it is guided past the printed-mark reader 22. The subsequent sequence in the apparatus corresponds to the abovedescribed exemplary embodiment.

1. Process for producing folded printing carriers made of thin material, namely folding coupons (10) made of paper, the folding coupon (10) being folded such that at least two folding legs (27, 28) are connected to one another by adhesive bonding, characterized by the following features:
a) areas of glue or regions of glue (18, 19) for adhesively bonding folding legs (27, 28) are applied in a precise position to a continuous material web (11) for producing the folding coupons (10),
b) the regions of glue (18, 19) consist of hot glue (hot melt),
c) blanks (25) are cut off from the material web (11) provided with set regions of glue (18, 19) and are fed to a folding subassembly (26) for carrying out folding operations and/or for producing the folding coupons (10),
d) once the blank (25) has been folded, the regions of glue (18, 19), consisting of hot glue, are activated by the supply of heat and the folding legs (27, 28) are connected to one another by pressure.

2. Process according to claim 1, characterized in that the regions of glue (18, 19) are applied during the production of the material web (11) and are made available to a packaging machine for producing packs with a folding coupon (10).

3. Process according to claim 1 or 2, characterized in that, in the case of two-web production by virtue of blanks (25) being cut off from a double-width material web (11), two adjacent regions of glue (18, 19) are applied in a precise position to the material web (11).

4. Process according to claim 1, characterized in that blanks (25) are cut off from a double-width and double-layered material web (11) and are then further processed for forming a double-width folding coupon (10) and subsequently severed for producing individual folding coupons (10), two folding legs (27, 28) of the material web being folded to coincide with a central region of the material web (11), such that the double-layered material web (11) has folding edges along both borders.

5. Process according to claim 4, characterized in that the legs (50, 51) of the material web (11) are spaced apart from one another by a small distance such that a longitudinal gap (52) is formed between the web legs (50, 51) in a longitudinal centre plane of the material web (11).

6. Process according to claim 4, characterized in that the non-folded material web (11) has applied to it at least two regions of glue (18, 19) for each folding coupon (11) which is to be produced, for the purpose of connecting more than two folding legs (27, 28, 29) to one another.

7. Process according to claim 6, characterized in that the folding coupons (10) produced from a two-layered blank (25) have two regions of glue (18, 19) for each folding coupon (10), the regions of glue (18, 19) being applied to opposite sides of the material web (11).

8. Apparatus for producing folded printing carriers—folding coupons (10)—by virtue of non-folded blanks (25) being cut off from a material web (11) and folded in the region of a folding subassembly (26), characterized in that the (non-folded) material web (11) can be moved past at least one glue subassembly (20, 21) for the purpose of transferring regions of glue (18, 19) to the material web (11), it being possible for the glue subassembly (20, 21) to be controlled, in accordance with printed marks on the material web (11), via at least one printed-mark reader (22), and for blanks (25) provided with regions of glue (18, 19) then to be cut off from the material web (11) in a precise position in the region of a severing subassembly (24) and fed to the folding subassembly (26).

9. Apparatus according to claim 8, characterized in that the—double-width—material web (11), following the glue subassemblies (20, 21), can be conveyed through a folding unit (63), it being possible for the material web (11) to be folded in a double layer in the region of the folding unit (63), with two web legs (50, 51) being formed along the borders in the process.

10. Apparatus according to claim 8 or 9, characterized in that the folding subassembly (26) is followed directly by an arrangement (34) for the post-treatment of the folding coupons (10), having a heating station (35) for transmitting heat to the folding coupons (10) and for pressing the folding legs (27, 28, 29) of the folding coupons (10) together.

11. Apparatus according to claim 10, characterized in that a severing station (36) is formed for severing double-width folding coupons (10) following the heating station (35), the station having at least one circulating, circular severing blade (44) on a blade roller (45), and a mating roller (46).

12. Apparatus according to claim 10, characterized in that the arrangement (34) for the post-treatment of the folding coupons (10) has a plurality of belt conveyors (37, 38, 39) for transporting the folding coupons (10), the belt conveyors (37, 38, 39) being spaced apart from one another and having heating elements (42) arranged between them for the purpose of transmitting heat to the folding coupons (10).

13. Apparatus according to claim 12, characterized in that the folding coupons (10), in the region of the heating station (35), can be transported between conveying strands (40, 41) of the belt conveyors (37, 38, 39) for the purpose of transferring pressure to the folding coupons (10).

14. Apparatus according to claim 8, characterized in that the material web (11) can be directed through a stamping element (56) in order for transversely directed scores (61) to be provided in accordance with folding lines of the folding coupons (10), the stamping element (56) being arranged to follow the folding unit (63) for producing double-layered material webs (11).
